(19) United States
(12) Patent Application Publication
(10) Pub. No.: US 2026/0303985 A1
(43) Pub. Date: Oct. 1, 2026

(54) SCENE LIGHTING ANALYSIS USING OPPOSING SMARTPHONE CAMERAS

(71) Applicant: SAMSUNG ELECTRONICS CO., LTD., Suwon-si (KR)

(72) Inventors: Oded BERBY, Tel-Aviv (IL); Evgeny SOLOVEICHIK, Netanya (IL); Genady PAIKIN, Netanya (IL); Roy SHAUL, Tel-Aviv (IL); Shira WERMAN, Tel-Aviv (IL)

(73) Assignee: SAMSUNG ELECTRONICS CO., LTD., Suwon-si (KR)

(21) Appl. No.: 19/097,069

(22) Filed: Apr. 1, 2025

(51) Int. Cl. H04N 23/88; G06T 7/90; H04N 23/71; H04N 23/90

(52) U.S. Cl. CPC H04N 23/88; G06T 7/90; H04N 23/71; H04N 23/90; G06T 2207/10024

(57) ABSTRACT

An electronic device includes: a first camera oriented in a first direction with respect to the electronic device; a second camera oriented in a second direction with respect to the electronic device, wherein the second direction is opposite to the first direction; and an image signal processor configured to: obtain a first image captured by the first camera; obtain information about ambient light captured by the second camera; calculate a color temperature based on the information about the ambient light; and perform color correction on the first image based on the calculated color temperature to obtain a color-corrected first image

### BACKGROUND

### 1. Field

The present disclosure relates to image processing, and more particularly to performing color correction and white balance correction using two opposing cameras.

### 2. Description of Related Art

Users of devices such as smartphones may use their devices to capture images in different situations and lighting conditions. Such devices often process these images in order to create a final image by applying corrections such as color corrections or white balance corrections. However, the algorithms used to perform the image processing may sometimes fail, causing the colors of objects in the scene to appear inaccurate due to incorrect identification of the spectrum of the ambient light that is present in the scene, which may be caused by unusual or unexpected scene types. For example, a user may capture an image of a clothing item in a store with specific ambient lighting to ask for another person's opinion on the color, but the colors of the clothing item may appear inaccurate in the image.

In order to obtain an image which includes accurate colors, some image processing approaches may analyze the light that is reflected from objects in the scene to predict the color temperature (e.g., a correlated color temperature (CCT)). However, these approaches may rely on assumptions about the scene type when predicting the color temperature of the scene and correcting colors of an image of the scene. These assumptions may lead to different outcomes under the same lighting, depending on the objects in the scene. For example, in situations in which there is a single dominant object in the photo, the assumptions may be inaccurate, resulting in an unreliable outcome that may change significantly with changes in the object.

### SUMMARY

Provided are systems, methods, and devices for performing color correction and white balance correction using two opposing cameras.

Additional aspects will be set forth in part in the description which follows and, in part, will be apparent from the description, or may be learned by practice of the presented embodiments.

In accordance with an aspect of the disclosure, an electronic device includes: a first camera oriented in a first direction with respect to the electronic device; a second camera oriented in a second direction with respect to the electronic device, wherein the second direction is opposite to the first direction; and an image signal processor configured to: obtain a first image captured by the first camera; obtain information about ambient light captured by the second camera; calculate a color temperature based on the information about the ambient light; and perform color correction on the first image based on the calculated color temperature to obtain a color-corrected first image.

In accordance with an aspect of the disclosure, a method for performing color correction, the includes: obtaining a first image captured using a first camera included in an electronic device, wherein the first camera is oriented in a first direction with respect to the electronic device; obtaining information about ambient light captured using a second camera included in the electronic device, wherein the second camera is oriented in a second direction with respect to the electronic device, wherein the second direction is opposite to the first direction; calculating a color temperature based on the information about the ambient light; and performing color correction on the first image based on the calculated color temperature to obtain a color-corrected first image.

In accordance with an aspect of the disclosure, an electronic device includes: a first camera disposed at a first side of the electronic device; a second camera disposed at a second side of the electronic device, wherein the second side is opposite to the first side; and an image signal processor configured to: obtain a first image captured by the first camera; obtain information about ambient light captured by the second camera; calculate a color temperature based on the information about the ambient light; and perform color correction on the first image based on the calculated color temperature to obtain a color-corrected first image.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system for performing image processing, according to embodiments;

FIG. 2 is a block diagram of an electronic device including the image processing system of FIG. 1, according to embodiments;

FIGS. 3A-3C are diagrams showing examples of scenes which may be captured using the image processing system, according to embodiments;

FIG. 4 is a diagram illustrating an example process for capturing an image of a scene, according to embodiments;

FIG. 5 is a diagram showing an example processing flow for capturing an image of a scene, according to embodiments;

FIGS. 6-7 are diagrams illustrating example processes for capturing images of scenes, according to embodiments;

FIG. 8 is a flowchart of an example process for performing color correction, according to embodiments.

### DETAILED DESCRIPTION

As discussed above, obtaining an image which includes accurate colors remains challenging, especially in images involving unusual scene types.

In order to obtain an image which includes accurate colors, some image processing approaches may analyze the light that is reflected from objects in the scene to predict a color temperature (e.g., a correlated color temperature (CCT)). However, these approaches may rely on assumptions about the scene type when predicting the color temperature of the scene and correcting colors of an image of the scene. These assumptions may lead to different outcomes under the same lighting, depending on the objects in the scene. For example, in situations in which there is a single dominant object in the photo, the assumptions may be inaccurate, resulting in an unreliable outcome that may change significantly with changes in the object.

Accordingly, embodiments of the present disclosure are directed to techniques for obtaining additional information about ambient light present in an scene in order to provide improved color correction and white balance correction. For example, embodiments may use opposite cameras in an electronic device such as a smartphone to capture an image of a scene while also measuring or determining a color temperature of ambient light that illuminates the scene. For example, according to embodiments, a front camera of an electronic device may be used to obtain information about the ambient light while an image is captured using a rear camera of the electronic device, or the rear camera of the electronic device may be used to obtain the information about the ambient light while the image is captured using the front camera. Accordingly, embodiments may allow for an accurate lighting spectrum analysis to be performed, which may then be used to perform a color correction or white balance correction on the image in order to provide a final image which includes accurate colors.

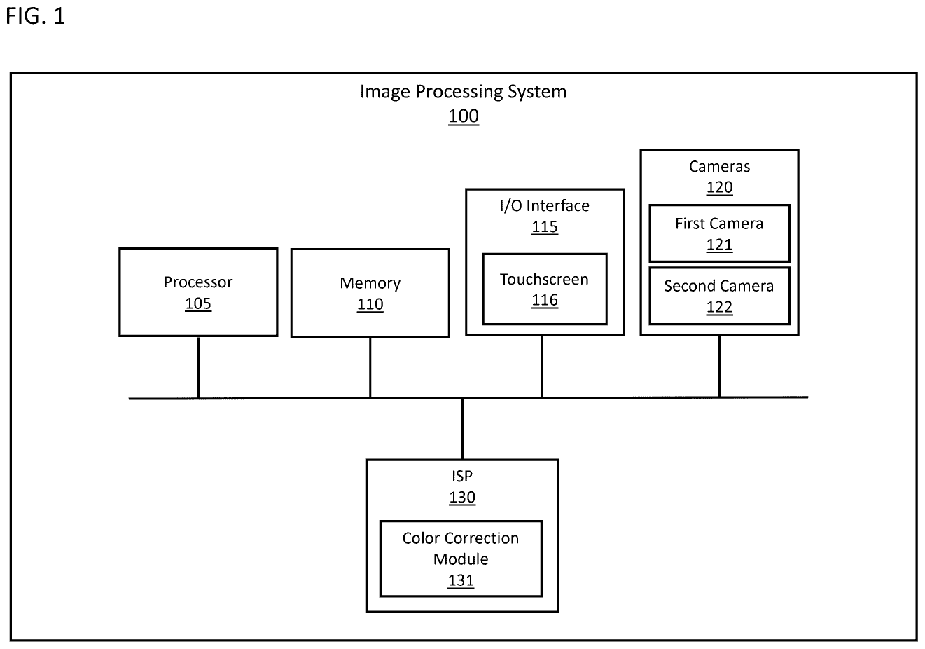

FIG. 1 is a block diagram of a system for performing image processing, according to embodiments. As shown in FIG. 1, the image processing system 100 may include a processor 105, a memory 110, an input/output (I/O) interface 115, one or more cameras 120, and an image signal processor (ISP) 130.

The processor 105 may be, or may include, an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 105 may be configured to operate a memory array using a memory controller. For example, a memory controller may be integrated into the processor 105. In embodiments, the processor 105 may be configured to execute computer-readable instructions stored in a memory to perform various functions. However, embodiments are not limited thereto, and the memory controller may be included in any other element of the image processing system 100, for example in the memory 110.

The memory 110 (e.g., a memory device) may include at least one of a random access memory (RAM), a read-only memory (ROM), and a hard disk. For example, the memory 110 may include a solid state memory and a hard disk drive. The memory 110 may be used to store computer-readable and computer-executable software including instructions which, when executed, may cause the processor 105 to perform various functions described herein. For example, the memory 110 may include, among other things, a basic input/output system (BIOS) which may control basic hardware or software operation such as the interaction with peripheral components or devices. In some cases, memory cells within the memory 110 store information in as a logical state of the memory cells.

The I/O interface 115 may manage signals which are input from and output to the image processing system 100 and the elements included therein. The I/O interface 115 may also manage peripherals which are not integrated into a device. For example, the I/O interface 115 may represent a physical connection or port to an external peripheral. In embodiments, the I/O interface 115 may utilize an operating system such as iOS®, ANDROID®, MS-DOS®, MS-WINDOWS®, OS/2®, UNIX®, LINUX®, or another operating system. In embodiments, the I/O interface 115 may represent, include or interact with a modem, a keyboard, a mouse, or a similar device. In embodiments, the I/O interface may include a touchscreen 116, which may be used to display images and receive touch inputs from a user. In embodiments, the I/O interface 115 may be implemented as part of a processor 105. In embodiments, a user may interact with a device using the I/O interface 115 or using hardware components controlled by the I/O interface 115.

The image processing system 100 may include an optical instrument (e.g., the one or more cameras 120, an image sensor, etc.) for recording or capturing images, which may be stored locally, transmitted to another location, etc. For example, the cameras 120 may capture visual information using one or more photosensitive elements that may be tuned for sensitivity to a visible spectrum of electromagnetic radiation. A resolution of the visual information may be measured in pixels, where each pixel may relate an independent piece of captured information. In embodiments, each pixel may correspond to one component of, for example, a two-dimensional (2D) Fourier transform of an image. Computation methods may use pixel information to reconstruct images captured by the device. In the camera 120, one or more image sensors may convert light incident on a lens of the camera 120 into an analog or digital signal. The image processing system 100 may then display an image on a display panel (e.g., the touchscreen 116) based on the digital signal. In embodiments, the one or more cameras may include, for example, a first camera 121 and a second camera 122.

A pixel (e.g., a pixel included in an image sensor) may store information about received electromagnetic radiation (e.g., light). Each pixel may include one or more photodiodes and one or more complementary metal oxide semiconductor (CMOS) transistors. A photodiode may receive a light and may output charges. The amount of output charges may be proportional to the amount of light received by the photodiode. CMOS transistors may output a voltage based on charges output from the photodiode. A level of a voltage output from the photodiode may be proportional to the amount of charges output from the photodiode. For example, the level of the voltage output from a photodiode may be proportional to the amount of light received by the photodiode.

The first camera 121 may comprise a first image sensor having a plurality of first photodiodes and a first resolution, and the second camera 122 may comprise a second image sensor having a plurality of second photodiodes and a second resolution less than the first resolution. A width of each of the plurality of first photodiodes in a third direction may be equal or greater than a width of each of the plurality of second photodiodes in the third direction. For example, the third direction may be perpendicular to the direction in which light is incident on the first or second image sensor. The first image sensor may be implemented on a first module, the second image sensor may be implemented on a second module, and the ISP 130 is implemented on a third module different from the first module and the second module.

The ISP 130 may perform image processing on an image obtained through the cameras 120, or image data stored in the memory 110. Image processing may include depth map generation, three-dimensional modeling, panorama generation, feature point extraction, image synthesis, and/or image compensation (e.g., noise reduction, resolution adjustment, brightness adjustment, blurring, softening, etc.). The ISP 130 may control (e.g., exposure time control, lead out timing control, etc.) other components (e.g., image sensors, etc.) included in the first camera 121 and/or the second camera 122. An image treated or processed by the ISP 130 may be stored again in the memory 110 for further processing or may be provided to another component (e.g., the I/O interface 115, the touchscreen 116, etc.). The ISP 130 may be integrated into the processor 105 or may be a separate processor operating independently of the processor 105. If the ISP 130 is a separate processor from the processor 105, an image processed by the ISP 130 may be displayed through the touchscreen 116 after going through an additional image processing by the processor 105.

The ISP 130 may include a color correction module 131. In some embodiments, the color correction module 131 may be referred to as a white balance module or a white balance correction module. For example, in some embodiments, the ISP 130 may receive a first image from a first path, captured by the first camera 121, which may be for example an image of a scene, and a second image from a second path, captured by the second camera, which may be for example an image of ambient light which illuminates the scene, or an image of a light source which provides the ambient light. The second path may be different from the first path.

The color correction module 131 may be used to adjust a white balance or a color temperature of the first image based on the determined color temperature. Accordingly, the ISP 130 may output a color-corrected first image having an accurate white balance. For example, in some embodiments, the ISP 130 may manipulate the relative intensities of red, green, and blue color channels to perform the color correction.

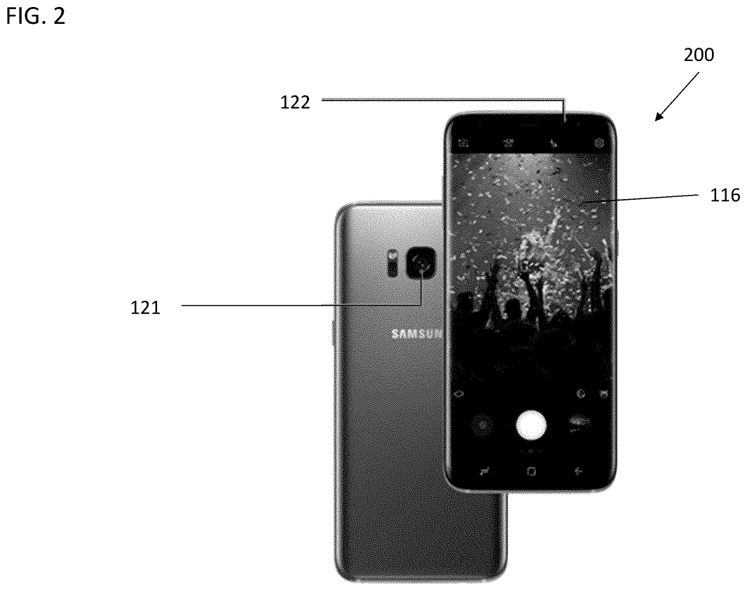

FIG. 2 is a block diagram of an electronic device including the image processing system of FIG. 1. In some embodiments, the electronic device 200 may be a mobile device such as a smartphone, but embodiments are not limited thereto. For example, according to embodiments, the electronic device 200 may be, or may include, a personal computer, a laptop computer, a tablet computer, a personal digital assistant, or any other type of electronic device. In embodiments, the electronic device 200 may include, or may be used to implement, the image processing system 100 and/or one or more of the components included therein, for example the ISP 130 and the components included therein.

As shown in FIG. 2, the electronic device 200 may include the first camera 121, the second camera 122, and the touchscreen 116. As shown in FIG. 2, the first camera 121 may face or be oriented in opposite directions with respect to the electronic device 200. For example, the first camera 121 may be oriented toward a first direction (e.g., a rear direction) with respect to the electronic device 200, the second camera 122 may be oriented toward a second direction (e.g., a front direction) with respect to the electronic device, and the first direction may be opposite to the second direction.

In embodiments, the first camera 121 and the second camera 122 may be disposed at or on opposite sides of the electronic device 200. For example, the first camera 121 may be disposed on a first side (e.g., a rear side) of the electronic device 200, and the second camera 122 may be disposed on a second side (e.g., a front side) of the electronic device 200, and the first side may be opposite to the second side. In some embodiments, the touchscreen 116 may also be disposed on the front side of the electronic device 200. According to embodiments, when a camera is described as being disposed “on” a particular side of the electronic device 200, this may mean that at least a portion of the camera (e.g., a lens, sensor, etc.) is collocated with or coplanar with the side, or is configured to capture an image from a perspective that is perpendicular to the particular side and facing outward from the electronic device 200.

Accordingly, the first camera 121 may be a rear-facing camera included in the electronic device 200, and the second camera 122 may be a front-facing camera included in the electronic device 200

The electronic device 200 may use the touchscreen 116 to display images such as one or more of the first image captured by the first camera 121, the second image captured by the second camera 122, a color-corrected first image, and any other image described herein with reference to FIGS. 1-8. In addition, the electronic device 200 may use the touchscreen 116 to display one or more user interfaces and to receive one or more user inputs.

Although examples are described herein in which the first camera 121 and the second camera 122 are oriented in opposite directions and/or disposed on opposite sides of the electronic device 200, embodiments are not limited thereto. For example, in some embodiments the first camera 121 and the second camera 122 may be oriented in different directions which are not opposite to each other, or may be disposed on different sides of the electronic device 200 which are not opposite to each other. For example, the first camera 121 may be disposed on a rear side of the electronic device 200, and the second camera 122 may be disposed on a right or left side of the electronic device 200. However, these are only examples, and embodiments are not limited thereto.

White balance may refer to a camera setting or image parameter that may be used to adjust the colors of an image (e.g., by scaling or otherwise manipulating the relative intensities of the red, green, and blue color channels) to set a color temperature of an image. Color temperature may be a parameter that indicates a color of light emitted by a light source by comparing this color to the color of light emitted by an ideal illuminant (e.g., an ideal black-body emitter). The temperature of the ideal illuminant that matches the color of the light source may be referred to as the color temperature of the light source. A color temperature may be expressed in degrees Kelvin (K), where higher values may indicate “cooler” light (e.g., daylight) and lower values may indicate “warmer” light (e.g., candlelight). The color temperature of a light source may refer only to the color of the light emitted by the light source, and may not necessarily refer to the actual temperature of the light source.

White balance correction, which may be referred to as correcting a color cast of the image or performing color correction on the image, may be a process for adjusting an image (e.g., by scaling or otherwise manipulating the relative intensities of the red, green, and blue color channels) so that it appears as if the ambient light in the scene was provided by a light source having a neutral color temperature, in order to ensure that objects that are actually white appear to be white in the final image. After the color correction or white balance correction is performed, colors in the image may look more natural and accurate to the human eye.

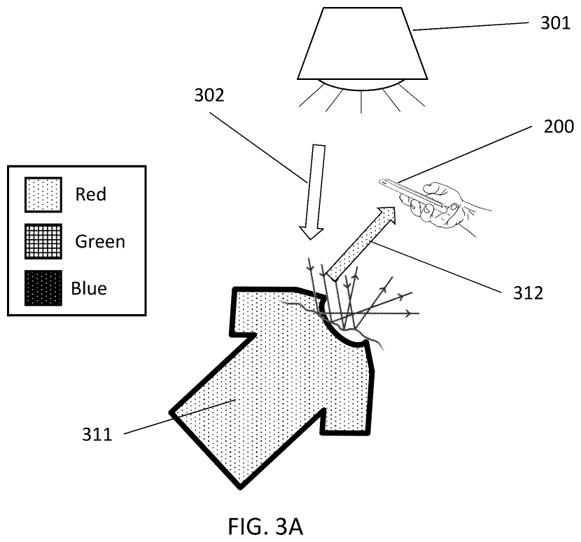

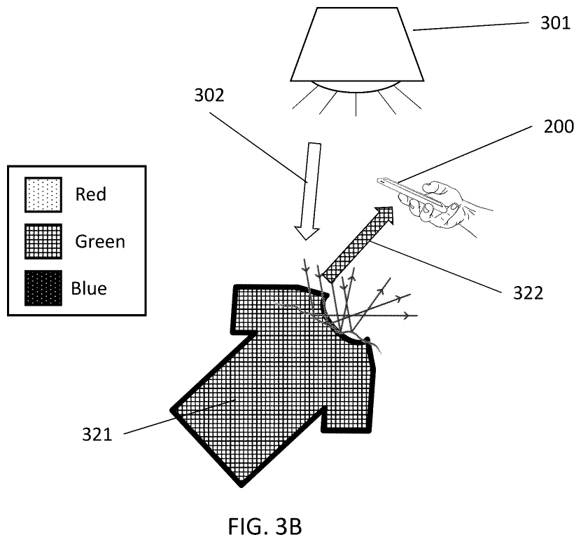

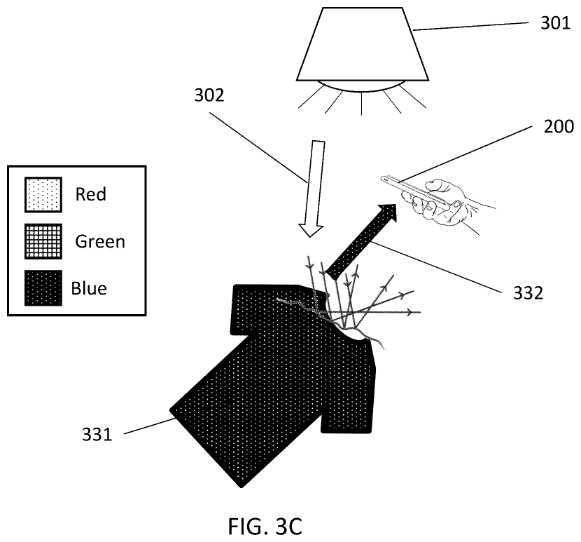

FIGS. 3A-3C are diagrams showing examples of scenes which may be captured using the image processing system, according to embodiments.

When capturing an image using a camera (e.g., the first camera 121 or the second camera 122), the white balance of the image, and therefore the color accuracy of the image, may depend on the light reflected from the scene. However, different objects included in the scene may reflect different light wavelengths, which may affect the white balance of the image.

For example, a s shown in FIG. 3A, a first object 311 that is red in color may be illuminated by ambient light 302 emitted from a light source 301, and the electronic device 200 may detect reflected light 312 having a red wavelength. However, as shown in FIGS. 3B-3C, when a second object 321 that is green in color is illuminated by the same ambient light 302 emitted from the light source 301, the electronic device 200 may detect reflected light 322 having a green wavelength, and when a third object 331 that is blue in color is illuminated by the same ambient light 302 emitted from the light source 301, the electronic device 200 may detect reflected light 332 having a blue wavelength.

Accordingly, if the white balance or color temperature of an image is set or adjusted using only the reflected light that is reflected from an object, there is no way to definitively determine whether the color of the reflected light is due to a color of the object, or due to a color of the light illuminating the object. As a result, under the same lighting conditions, images of different objects may lead to different white balance calculations. Accurately determining the spectrum of ambient lighting at the scene may be important for determining a true white balance for an image.

According to embodiments, an image model for single illumination scene may be represented according Equation 1 below:

$${I}_{k} ( x , y ) = {\int }_{Λ} R ( x ; y ; λ ) L ( λ ) {f}_{k} ( λ ) d λ . \qquad ( Equation 1 )$$

In Equation 1 above, (x, y) may denote the spatial coordinates of a given pixel, k may denote the channel index (which may indicate, for example, one of a red color channel, a green color channel, and a blue color channel), fₖ(λ) may denote the system response function for the k-th channel, Iₖ may denote the k-th channel of the observed image (e.g., one of a red channel, a green channel, and a blue channel), and λ may denote the parameter indicating the observed wavelength of light. In addition, R may denote the reflectance of the scene, and L may denote the illuminant.

According to embodiments, a white balance of an image may be found by determining the color of the illuminant (e.g., L). Once the color of the illuminant is found, then a color correction or white balance correction may be performed by adjusting the color temperature of the image (e.g., manipulating the relative intensities of the color channels) so that the scene appears to be under neutral lighting. However, determining the illuminant L, (e.g., separating the reflectance R and the illuminant L in Equation 1) is an ill-posed problem that is fundamentally under-determined.

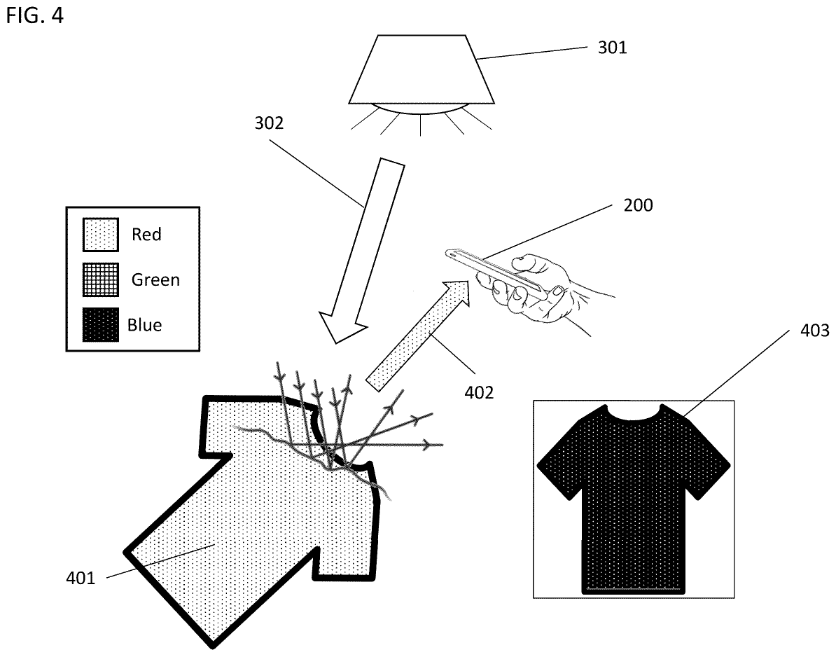

FIG. 4 is a diagram illustrating an example process for capturing an image of a scene, according to embodiments. As shown in FIG. 4, an object 401 that is red in color may be illuminated by the ambient light 302 emitted from the light source 301, the electronic device 200 may detect reflected light 312 having a red wavelength, and the electronic device 200 (e.g., the ISP 130) may generate an image 403 based on the reflected light 312. However, if the image 403 does not provide enough information about the ambient light 302 (for example, if the object 401 occupies a relatively large portion of the image 403), then it may be difficult for the electronic device 200 to correctly calculate or identify a color temperature of the ambient light 302 emitted by the light source 301 (e.g., the ambient light of the scene including the object 401). As a result, the electronic device 200 may generate an image 403 in which the object 401 is represented using incorrect colors.

Overcoming the under-determined nature of this problem is a difficult challenge in color correction algorithms and white-balance correction algorithms, and many algorithms may fail when the scene is not sufficiently diverse, as in the example shown in FIG. 4.

Accordingly, embodiments may improve the white balance and color temperature determination by eliminating the need for assumptions and guesswork in the process described above. By using an opposite camera, which may be oriented in a direction which crosses the light path of light illuminating the object being photographed by the first camera, the light (e.g., the ambient light illuminating the scene) may be analyzed independently of the light reflected from the scene being captured.

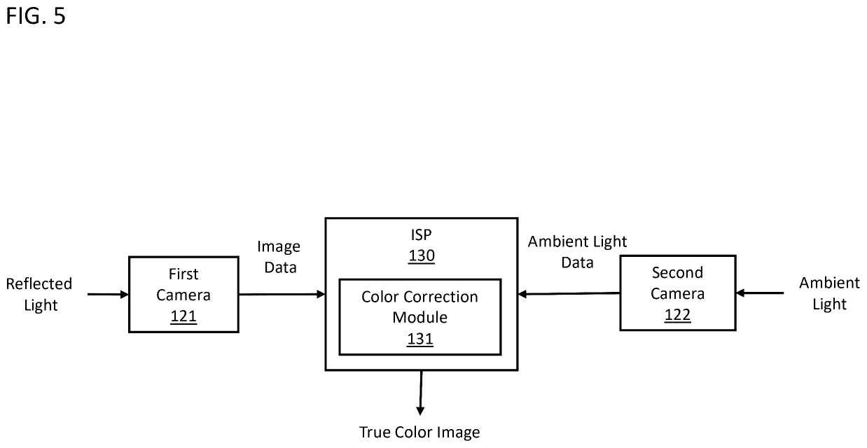

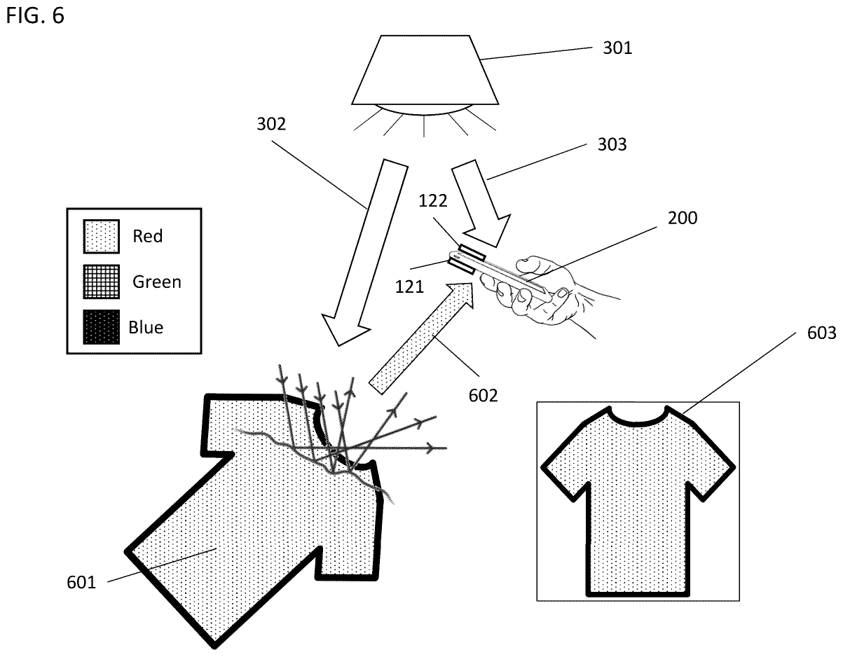

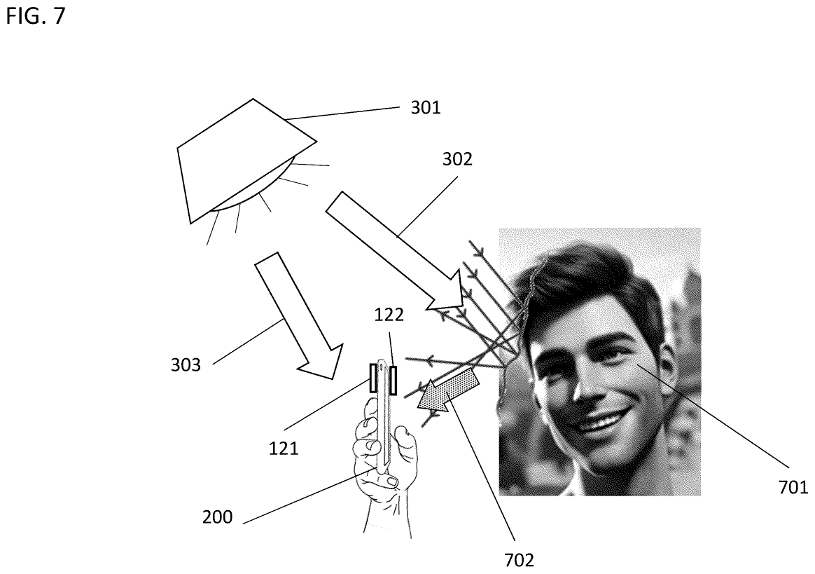

FIG. 5 is a diagram showing an example processing flow for capturing an image of a scene, according to embodiments, and FIGS. 6-7 are diagrams illustrating example processes for capturing images of scenes, according to embodiments.

As shown in FIG. 5, in addition to capturing an image with the first camera 121 based on reflected light, embodiments may determine a color temperature or white balance for the image using information obtained from the second camera 122 based on ambient light included in the scene.

For example, referring to FIG. 6, when the electronic device 200 is positioned such that the first camera 121 is able to capture the reflected light 602 that is reflected from the object 601 included in the scene, this may mean that second camera 122 has a direct view of the light source 301 which provides the ambient light 302, and may therefore collect ambient light 303 in order to determine a white balance or color temperature corresponding to the light source 301. Accordingly, in the example shown in FIGS. 5-6, the first camera 121 may generate image data based on the reflected light 602 in order to generate an image 603 of the scene (e.g., a first image), and the second camera 122 may collect the ambient light 303 emitted by the light source 301, and may generate ambient light data based on the ambient light in order to perform color correction or white balance correction on the image 603. In some embodiments, the ambient light data may be image data, or may be obtained by or based on an image that is generated based on the ambient light. For example, the ambient light data may be, or may be obtained from, an image (e.g., a second image) captured by the second camera 122, but embodiments are not limited thereto.

In embodiments, the camera used to capture the image of the scene may be referred to as a “main” camera, and the camera used to capture the ambient light may be referred to as an “opposite” camera. Accordingly, in the example shown in FIG. 5, the first camera 121 may be referred as the main camera, and the second camera 122 may be referred to as the opposite camera, but embodiments are not limited thereto. As discussed above, by facing the light source and capturing the illuminant, the opposite camera may be used as a colorimeter to determine the light spectrum and the color temperature (e.g., the correlated color temperature (CCT)) of the light source. Using the signals (e.g., the ambient light data) from the opposite camera (e.g., the second camera 122 in FIG. 5), an image model for a single illumination scene may be represented according Equation 2 below:

$${I}_{k} ( x , y ) = {\int }_{Λ} L ( λ ) {f}_{k} ( λ ) d λ . \qquad ( Equation 2 )$$

According to embodiments, the system response fₖ for the first camera 121 and the system response fₖ for the second camera 122 may be known in advance by the electronic device 200. Accordingly, Equation 2 may be a well-defined equation that may simplify the white balance problem, which may enable an accurate white balance assessment and allow a white balance correction or color correction that results in realistic and natural image colors. For example, after calculating an accurate color temperature for the ambient light 303 (and therefore for the ambient light 302), the ISP 130 and/or the color correction module 131 may perform color correction or white balance correction by setting the white balance of the image 603 to the calculated color temperature, or to another color temperature that causes the scene to appear as if it is under neutral lighting. Therefore, the electronic device 200 may generate an image 603 which has colors that are more accurate than the colors in the image 403 described above.

Although examples are described herein in which the image is captured by the first camera 121 and the ambient light data is collected by the second camera 122, embodiments are not limited thereto. For example, as shown in FIG. 7, a user may wish to use the electronic device 200 to capture an image of the user's face 701 (e.g., a “selfie” image). Therefore, the second camera 122 may be used to collect reflected light 702 that is reflected from the user's face 701, and the first camera 121 may be used to collect the ambient light 303 directly from the light source 301. As a result, in the example shown in FIG. 7, the second camera 122 may be the main camera, and the first camera 121 may be the opposite camera.

In addition, although examples are described herein in which the white balance or color temperature is determined only based on the ambient light data provided by the opposite camera, embodiments are not limited thereto. For example, in some embodiments, the electronic device 200 or elements included therein (e.g., the ISP 130 and the color correction module 131) may detect or determine whether an image has a high likelihood of having incorrect white balance, for example by determining that an image is not sufficiently diverse, or that a white balance or color temperature that is calculated based on reflected light is unusual or unexpected, and based on this determination may then proceed to obtain the ambient light data using the opposite camera in order to verify or correct the previously-calculated white balance. As another example, the electronic device 200 or elements included therein (e.g., the ISP 130 and the color correction module 131) may calculate the white balance or color temperature based on a combination of the reflected light and the ambient light captured by both cameras.

Also, although examples are described herein in which the white balance or color correction is performed so that the resulting image appears as if it was captured under neutral lighting, embodiments are not limited thereto. For example, after an accurate color temperature of the light source is determined, this information may be used to modify the captured image to create any desired effect. For example, the color temperature or white balance of the image may be adjusted so that the image appears as if it was captured under any desired lighting condition.

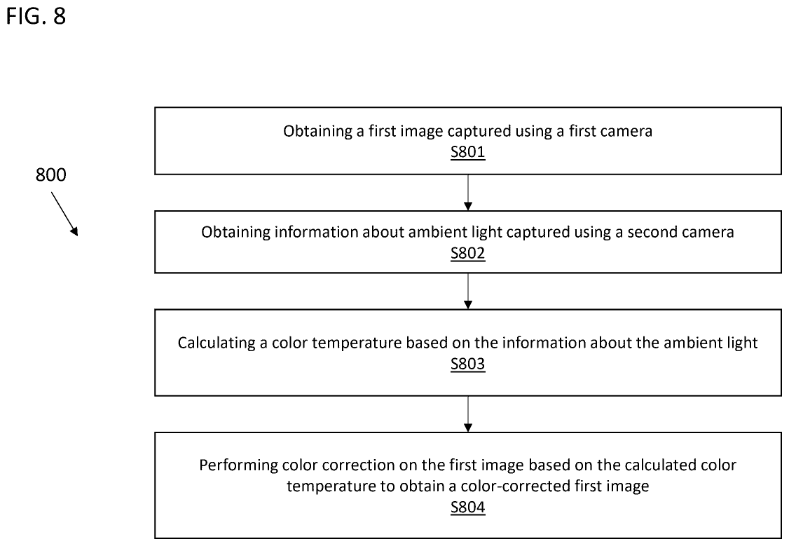

FIG. 8 is a flowchart of an example process for generating a combined image, according to embodiments. In some implementations, one or more process blocks of FIG. 8 may be performed by any of the elements discussed above, for example one or more of the image processing system 100, the electronic device 200, and any of the components included therein, such as ISP 130 and the color correction module 131.

As shown in FIG. 8, at operation S801 the process 800 may include obtaining a first image captured using a first camera included in an electronic device. In embodiments, the first camera may correspond to the main camera discussed above, and may be oriented in a first direction with respect to the electronic device.

As further shown in FIG. 8, at operation S802 the process 800 may include obtaining information about ambient light captured using a second camera. In embodiments, the information about the ambient light may correspond to the ambient light data discussed above. In embodiments, the second camera may correspond to the opposite camera discussed above, and may be oriented in a second direction with respect to the electronic device. In embodiments, the second direction may be opposite to the first direction. In embodiments, both the first camera and the second camera may be included in single electronic device, for example the electronic device 200 discussed above. In embodiments, the first image and the information about the ambient light may be captured simultaneously, or may be captured at different time.

As further shown in FIG. 8, at operation S803 the process 800 may include calculating a color temperature based on the information about the ambient light. In embodiments, the color temperature may be a color temperature of or corresponding to the ambient light emitted from a light source.

As further shown in FIG. 8, at operation S804 the process 800 may include calculating a color temperature based on the information about the ambient light.

In embodiments, the information about the ambient light may be obtained from a second image captured by the second camera.

In embodiments, the first image may include an image of an object that is illuminated by the ambient light, the second image may include a light source corresponding to the ambient light, and the color-corrected first image may include a color-corrected image of the object.

In embodiments, the calculating of the color temperature may include determining an illuminant color corresponding to the light source without calculating a reflectance of the object.

In embodiments, the electronic device may include a first side and a second side. The first side may be opposite to the second side, the first camera may be disposed at the first side, and the second camera may be disposed at the second side.

In embodiments, the second side of the electronic device may further include a touchscreen display. Accordingly, the first camera (e.g., the main camera) may correspond to the first camera 121 discussed above, and the second camera (e.g., the opposite camera) may correspond to the second camera 122 discussed above. In embodiments, the object may be disposed in an environment of a user of the electronic device.

In embodiments, the first side of the electronic device may further include a touchscreen display. Accordingly, the first camera (e.g., the main camera) may correspond to the second camera 122 discussed above, and the second camera (e.g., the opposite camera) may correspond to the first camera 121 discussed above. In embodiments, the object may be a user of the electronic device.

In embodiments, the performing the color correction may include correcting a white balance of the first image based on the calculated color temperature.

Although FIG. 8 shows example blocks of the process 800, in some implementations, the process 700 may include additional blocks, fewer blocks, different blocks, or differently arranged blocks than those depicted in the process 800. Additionally, or alternatively, two or more of the blocks of the process 800 may be arranged or combined in any order, or performed in parallel.

Accordingly, embodiments may provide an innovative approach to mobile photography, and particularly to determining an accurate color temperature of a light source so that the white balance or color temperature of an image may be accurately set or adjusted. Therefore, embodiments may allow a true color image to be generated independent of the nature of the scene or field of view.

As a result, embodiments may assist a user in obtaining feedback or assistance from others who are not present. For example, the user may capture a color-accurate image of a product while shopping in various environments with different lighting conditions, which may assist the user or others in determining whether to make a purchase. In addition, a user may capture a color-accurate selfie image even in challenging lighting conditions, which may assist the user in determining an accurate skin tone of the user while purchasing makeup or other accessories.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. An electronic device, comprising:
a first camera oriented in a first direction with respect to the electronic device;
a second camera oriented in a second direction with respect to the electronic device, wherein the second direction is opposite to the first direction; and
an image signal processor configured to:
receive a first image captured by the first camera by capturing a first object;
receive a second image captured by the second camera by capturing a second object;
calculate a color temperature based on the second image about ambient light that illuminates the first object; and
perform color correction on the first image based on the calculated color temperature to obtain a color-corrected first image,
wherein the first camera comprises a first image sensor having a plurality of first photodiodes and a first resolution, and
wherein the second camera comprise a second image sensor having a plurality of second photodiodes and a second resolution less than the first resolution.

2. The electronic device of claim 1, wherein a width of each of the plurality of first photodiodes in a third direction is equal or greater than a width of each of the plurality of second photodiodes in the third direction.

3. The electronic device of claim 2, wherein the image signal processor is configured to receive the first image from a first path and receive the second image from a second path different from the first path.

4. The electronic device of claim 3, wherein to calculate the color temperature, the image signal processor is further configured to determine an illuminant color corresponding to a light source corresponding to the ambient light without calculating a reflectance of the first object.

5. The electronic device of claim 4, further comprising a first side, a second side, and a display,
wherein the first side is opposite to the second side,
wherein the first camera is disposed at the first side, and
wherein the second camera the display are disposed at the second side.

6. The electronic device of claim 5, wherein the first image sensor is implemented on a first module, the second image sensor is implemented on a second module, and the image signal processor is implemented on a third module different from the first module and the second module.

7. The electronic device of claim 1, wherein to perform the color correction, the image signal processor is further configured to manipulate the relative intensities of red, green, and blue color channels.

8. The electronic device of claim 1, wherein to perform the color correction, the image signal processor is further configured to correct a white balance of the first image based on the calculated color temperature.

9. A method for performing color correction, the method comprising:
receiving a first image captured using a first camera included in an electronic device, wherein the first camera is oriented in a first direction with respect to the electronic device;
receiving a second image captured by a second camera included in the electronic device, wherein the second camera is oriented in a second direction with respect to the electronic device, wherein the second direction is opposite to the first direction;
calculating a color temperature based on the second image about ambient light that illuminates the first object; and
performing color correction on the first image based on the calculated color temperature to obtain a color-corrected first image,
wherein the first camera comprises a first image sensor having a plurality of first photodiodes and a first resolution, and
wherein the second camera comprise a second image sensor having a plurality of second photodiodes and a second resolution less than the first resolution.

10. The method of claim 9, wherein a width of each of the plurality of first photodiodes in a third direction is equal or greater than a width of each of the plurality of second photodiodes in the third direction.

11. The method of claim 10, wherein the image signal processor is configured to receive the first image from a first path and receive the second image from a second path different from the first path.

12. The method of claim 11, wherein the calculating of the color temperature comprises determining an illuminant color corresponding to a light source corresponding to the ambient light without calculating a reflectance of the first object.

13. The method of claim 11, wherein the electronic device comprises a first side, and a second side,
wherein the first side is opposite to the second side,
wherein the first camera is disposed at the first side, and
wherein the second camera is disposed at the second side.

14. The method of claim 13, wherein the first side of the electronic device further comprises a touchscreen display, and
wherein the first object is a user of the electronic device.

15. The method of claim 13, wherein the second side of the electronic device further comprises a touchscreen display, and
wherein the first object is disposed in an environment of a user of the electronic device.

16. The method of claim 9, wherein the performing the color correction comprises correcting a white balance of the first image based on the calculated color temperature.

17. An electronic device, comprising:
a first camera disposed at a first side of the electronic device;
a second camera disposed at a second side of the electronic device, wherein the second side is opposite to the first side; and
an image signal processor configured to:
receive a first image captured by the first camera by capturing a first object;
receive a second image captured by the second camera by capturing a second object;
calculate a color temperature based on the second image about ambient light that illuminates the first object; and
perform color correction on the first image based on the calculated color temperature to obtain a color-corrected first image.

18. The electronic device of claim 17, wherein the first camera comprises a first image sensor having a plurality of first photodiodes and a first resolution, and
wherein the second camera comprise a second image sensor having a plurality of second photodiodes and a second resolution less than the first resolution.

19. The electronic device of claim 18, wherein the first side of the electronic device further comprises a touchscreen display, and
wherein the first object is a user of the electronic device.

20. The electronic device of claim 18, wherein the second side of the electronic device further comprises a touchscreen display, and
wherein the first object is disposed in an environment of a user of the electronic device.
